(19) United States
(12) Patent Application Publication
(10) Pub. No.: US 2016/0004880 A1
(43) Pub. Date: Jan. 7, 2016

(54) Method and System for Personal Identity Verification

(71) Applicant: uVerified LLC, Palos Verdes Estates, CA (US)

(72) Inventors: Harley Collins, Marina del Rey, CA (US); David Armitage, Palos Verdes Estates, CA (US)

(21) Appl. No.: 14/753,657

(22) Filed: Jun. 29, 2015

Related U.S. Application Data
(60) Provisional application No. 61/998,576, filed on Jul. 1, 2014.

(51) Int. Cl. G06F 21/62

(52) U.S. Cl. CPC G06F 21/6245

(57) ABSTRACT

A personal identification system for using a personal identification number (PIN) to provide personalized information on a user to a non-user is provided. In one embodiment of the present invention, a host computer is configured to communicate with at least a user computer, a non-user computer, and a verification computer, and to allow a user to create a user account, verify the user's identity, request background information on the user, request at least one PIN, and link a PIN with a verification type. The host computer may further be configured to communicate with the verification computer to acquire personalized data on the user, and to communicate with the non-user computer to provide personalized information on the user in response to entry of a PIN, where the type of personalized information provided is based on the verification type linked to the PIN.

### CROSS-REFERENCE TO RELATED APPLICATIONS

This application claims priority pursuant to 35 U.S.C. §119(e) to U.S. provisional patent application, Ser. No. 61/998,576, filed Jul. 1, 2014, the subject matter of which is incorporated by reference herein in its entirety.

### BACKGROUND OF THE INVENTION

1. Field of the Invention

The present invention relates to the field of personal identity verification and more particularly to an improved system and method for using a personal identification number (PIN) to provide personalized information on a user (e.g., user's credit report, user's criminal background, etc.) to at least one non-user, or a non-user computer.

2. Description of Related Art

There are many situations in which it is desirable to acquire personalized information on an individual. For example, in a commercial setting, it may be necessary to conduct a background investigation on an individual. Such an investigation may be necessary when the individual seeks employment or housing. In conducting such an investigation, it is common for employers and landlords to retain an outside investigative service to perform the background check. Such a service will typically conduct the background check by searching a number of public and/or proprietary databases, such as to verify bank records, credit history, employment history, arrest records, etc. The prospective employee or tenant may be asked to supply some basic information (e.g., social security number, last employer name, previous mailing address, driver's license number, etc.) in an application form, and in some cases to pay a fee associated with obtaining the background check. Thus, the entire burden of obtaining and evaluating the background check falls almost entirely on the entity seeking the information, e.g., the employer or landlord. Furthermore, the types of information that can be acquired by a third-party (e.g., an employer, a landlord, etc.) is limited since the information is not be requested (or authorized) by the individual themselves. Because of this many third-parties will just skip the background check entirely, and simply hope that the individual is who they purport to be (e.g., non-violent, financially stable, etc.).

But background checks are not limited to commercial settings, and are also applicable to social settings. For example, when one person interacts with another on the Internet (e.g., for friendship, information, dating, etc.), they may want to acquire certain information on the other person before they invest any significate amount of time conversing or agree to meet. While the increasing availability of social media on the internet has provided tremendous opportunities for individuals to meet and interact with each other, it has also exposed the participants to risks due to the anonymous nature of such interactions.

Similarly, as online dating sites continue to replace traditional methods of initially meeting people, the need to enhance the experience in terms of security and basic aspects subjective to the profile creator will increase as well. The dating websites that millions of people use do not validate a person's basic characteristics such as age, marital status, accuracy of photos, gender and most importantly criminal history. According to a joint report by Reuters, Herald News, PC World and the Washington Post—10% of Registered Sex Offenders use online dating sites to meet people. In fact, eHarmony alone boasts 55 million users with competitors like Match, okcupid and other top sites claiming membership in the tens of millions. There have been well publicized cases of people misrepresenting themselves on dating sites that have led to scandals, theft, rape, and even murder.

Currently there is no practical way for people using the Internet to verify the accuracy of the information received from other anonymous users. Even the background investigative services adapted for use by businesses and landlords to screen potential employees and tenants are unsuitable to verifying individuals in social settings. Most people simply lack the ability to check the criminal history of a person met online or in other informal settings, such as in a bar or other public place.

Accordingly, it would be desirable to provide a convenient system and method for providing accurate and complete personal information on a user, and to do so in a way that shifts the burden of acquiring the information from the person or entity that desires the information (the non-user) to the person or entity that the information is on (the user). Such a system can be used in both commercial and personal settings.

### SUMMARY OF THE INVENTION

The present invention provides an improved system and method for using a personal identification number (PIN) to provide personalized information on a user to at least one non-user, or at least one non-user computer. In preferred embodiments of the present invention, a system is used to verify that a user is operating a user computer, acquire personalized information on the user, generate at least one personal identification number (PIN), and use the PIN to provide the personalized information (or a portion thereof) to a non-user computer.

In one embodiment of the present invention, a host computer is configured to communicate with a plurality of computers via a wide area network (e.g., the Internet), including at least one user computer, a plurality of non-user computers, and a plurality of verification computers, and at least one staff computer over a network (e.g., a LAN, Internet, etc.). The host computer preferably includes at least one database and at least one application, wherein the application is configured to communicate with at least four types of devices (e.g., user, non-user, verification, and staff). In particular, the application may be configured to communicate with the user computer, allowing a user to (i) create a user account, (ii) verify the user's identity, (iii) request background information on the user, (iv) request at least one PIN, and (v) link a PIN with a verification type. The application may further be configured to communicate with the verification computers and/or the staff computer to acquire personalized data on the user.

The application may also be configured to communicate with at least one non-user computer. In particular the application may be configured to provide personalized information on the user in response to entry of a PIN, where the type (or portion) of the personalized information provided to the user is based on the verification type linked to the PIN provided by the non-user computer. For example, if the user requests a PIN and links to the PIN to social verification (e.g., age, marital status, criminal record, etc.), then the application will provide such information to a non-user computer in response to entering the PIN. In other words, by linking the PIN to social verification, the user is instructing the application to provide social verification data (e.g., age, marital status, criminal record, etc.) in response to entry of the PIN (e.g., by a non-user computer). This allows the user to control the type (or amount) of information provided in response to entry of the PIN (e.g., by a non-user, such as a third party). Such a system not only puts the burden of verification on the user, but it also ensures that the personalized information is complete, since the user is the one requesting (or authorizing) the background check, and can review the acquired information for accuracy prior to the information being provided to a non-user.

In one embodiment of the present invention, the application may be configured to allow an individual to become a member of the verification system by allowing the individual to generate (or create) an account. This may be done by allowing the individual to enter certain personal information (e.g., name, address, age, social security number, etc.), and select a user name and a password. The user name and password will allow the individual to subsequently log onto their account and interact with the system (e.g., request a background check, check status of an order, check non-user access to their personal information, request a PIN, link a PIN to a type of verification, change their settings, change their personal information, change their password, etc.).

After an individual has an account, the individual may request that the system run at least one background check on a user. Prior to running a background check, the system may first verify that the individual is indeed the user (i.e., that the user is indeed operating the user computer). This is generally done by gathering data that only the user would know, such as where they were born, where they went to school, where they previously lived, etc. Questions are then presented to the operator of the user computer. If the answers provided are accurate, then it is assumed that the operator of the user computer is indeed the user, and a background check on the user is performed.

In one embodiment of the present invention, the system (e.g., application) may also be configured to validate a photo received by the user. In this embodiment, the system can either take a photo of the user (e.g., using a camera portion of the user computer), or allow the user to upload a photo. The system will then use features of the photo (or file) to validate the photo. In one embodiment, the features used are metadata to ensure that the photo was taken at a particular time, at a particular location, from a particular device, from a particular IP address, etc. In another embodiment of the present invention, the system will provide the user with a PIN (or other secure alpha, numeric, or alphanumeric value) and request that the user take a photo holding a printout of the PIN. The system will then use the PIN (as included in the photo), either alone or in conjunction with other data (e.g., metadata), to validate the photo. Once the photo has been validated, the system may use facial recognition software (as known in the art) to match the individual in the photo (e.g., with the PIN) to other photos (as uploaded by the user). This allows the user to submit a system photo (with PIN), and then submit other photos that are appropriate for sharing with non-users.

Once the system has information on the user (e.g., at least one photo, background information, etc.), the information (or a portion thereof) can be shared with a third party, referred to herein as a “non-user.” To begin the process of sharing information, the system will first receive a request for a particular type of PIN (e.g., an employment PIN, social PIN, etc.) from the user. They system will then generate a PIN and link the PIN to the user and the user-identified verification type (e.g., employment, social, etc.). For example, if the user requests an “employment PIN,” then the PIN will be linked to an employment verification type. Similarly, if the user selects a “social PIN” or “housing PIN,” then the PIN will be linked to a social or housing verification type, respectively. The PIN will then be provided to the user, allowing it to be shared to a non-user (e.g., potential employer, potential mate, etc.).

Once a non-user has the PIN, the PIN can be provided to the system to receive information that is linked to the PIN (e.g., a particular subset of information on the user). For example, once the PIN is validated, a determination is then made as to what information the PIN is linked to. For example, if the PIN is linked the user and “employment,” then personalized information on the user that is related to employment (e.g., education, past work experience, criminal history, etc.) is provided to the non-user. If the PIN is linked to the user and “social,” then personalized information on the user that is related to social (e.g., age, marital status, photo, criminal background, etc.) is provided to the non-user. Finally, if the PIN is linked to the user and “housing,” then personalized information on the user that is related to housing (e.g., credit rating, employment, etc.) is provided to the non-user.

As discussed above, the present invention can be used in a number of commercial and social settings. By way of example, in a case where a girl (Jill) has just signed up with a dating website and is very excited to meet a great guy. She is honest about herself—provides photos, age, job and marital status and has a clean criminal history. Within 24 hours of signing up she gets dozens of responses from several guys. She decides to meet one (Jack) in person after corresponding with him for several days. She is excited to meet him at a restaurant. When Jack shows up he is obviously older than he had stated and in worse shape than when his picture was taken. Since she is already there, Jill decides to continue the date, but over dinner finds out that Jack is on probation for domestic battery and is still married, but in the process of getting a divorce. This is a very bad experience that has played out many times for individuals that are members of dating sites.

Using the exemplary invention, Jill obtains a verification code and shares that with guys she meets online to prove that she is who she purports to be. And before she meets with any guys, she insists that they provide their own verification codes. Many guys will not agree to obtain a verification code because they are misrepresenting themselves. But many will and Jill can be more confident in the people she has not met but is interested in meeting in person. She meets a person named Brad who has given Jill his verification code. Jill is impressed as he is attractive in the photo that has been verified and is in her age range and has a clean criminal history. Jill meets Brad for coffee and immediately recognizes him. She now sees that the present verification system and method has worked and will use this strategy for meeting new people in the future.

Job seekers and employers may also use the verification site to run background checks on criminal, employment and if needed financial histories. For example, in a case where John was recently laid off from the IT department of a major bank, John has been applying for jobs online for 3 months with no real leads. The nature of his work—access to expensive equipment and confidential information on employees and company information—requires him to have extensive background checks. Because he is aware of this he knows the application process will be longer and selective. He then discovers the present invention and uses the verification website to perform background checks that his employer normally would. He is then given a code he can put onto his resume that will allow potential employers to see results of this background check. Employers that he sends his resume to then go to the verification site and enter that code. Now they can see John has a verified work history, clear background check and has thus demonstrated transparency in the selection process early on and agree to meet him over other applicants they must take at face value. This gives John an edge over other job seekers and he now gets more interviews and opportunities as a result.

As can be seen, the foregoing system is advantageous over other verification systems in that it shifts the burden of acquiring the information from the person or entity that desires the information (the non-user) to the person or entity that the information is on (the user). Further, because the individual being checked is the one requesting (or authorizing) the information, the information is more likely accurate and complete than if it was requested by a third party. Finally, because the user is the one requesting PINs, different information can be given to different non-users, depending on their needs. Because of this, the system can be used to provide employer's with educational and employment history, while at the same time provide a potential date with more personal information (e.g., age, marital status, etc.).

A more complete understanding of a system and method for using a PIN to provide personalized information on a user to at least one non-user will be afforded to those skilled in the art, as well as a realization of additional advantages and objects thereof, by a consideration of the following detailed description of the preferred embodiment. Reference will be made to the appended sheets of drawings, which will first be described briefly.

### BRIEF DESCRIPTION OF THE DRAWINGS

FIG. 1 illustrates a system in accordance with one embodiment of the present invention for providing personalized information on a user to at least one non-user computer;

FIG. 2 illustrates a method in accordance with one embodiment of the present invention for validating a user, ensuring that the user computer is being operated by the user;

FIG. 3 illustrates a method in accordance with one embodiment of the present invention for allowing a user to setup an account and acquire personalized information on the same;

FIG. 4 illustrates a method in accordance with one embodiment of the present invention for using a personal identification number (PIN) to validate a user photo;

FIG. 5 illustrates a method in accordance with one embodiment of the present invention for generating and providing a PIN, where the PIN can be used to acquire personalized information on the user;

FIG. 6 illustrates a method in accordance with one embodiment of the present invention for using the PIN to acquire personalized information on the user;

FIG. 7 illustrates a system in accordance with another embodiment of the present invention for providing personalized information on a user to at least one non-user computer;

FIG. 8 illustrates an exemplary host computer of the system depicted in FIGS. 7;

FIG. 9 illustrates a method in accordance with one embodiment of the present invention for allowing a user to associate a particular PIN with a type of verification service; and

FIG. 10 illustrates a method in accordance with another embodiment of the present invention for providing personalized information on a user to at least one non-user computer.

### DETAILED DESCRIPTION OF THE PREFERRED EMBODIMENT

An embodiment of the present invention includes a system and method for using a personal identification number (PIN) to provide personalized information on a user (e.g., user's credit report, user's criminal background, etc.) to at least one non-user, or a non-user computer.

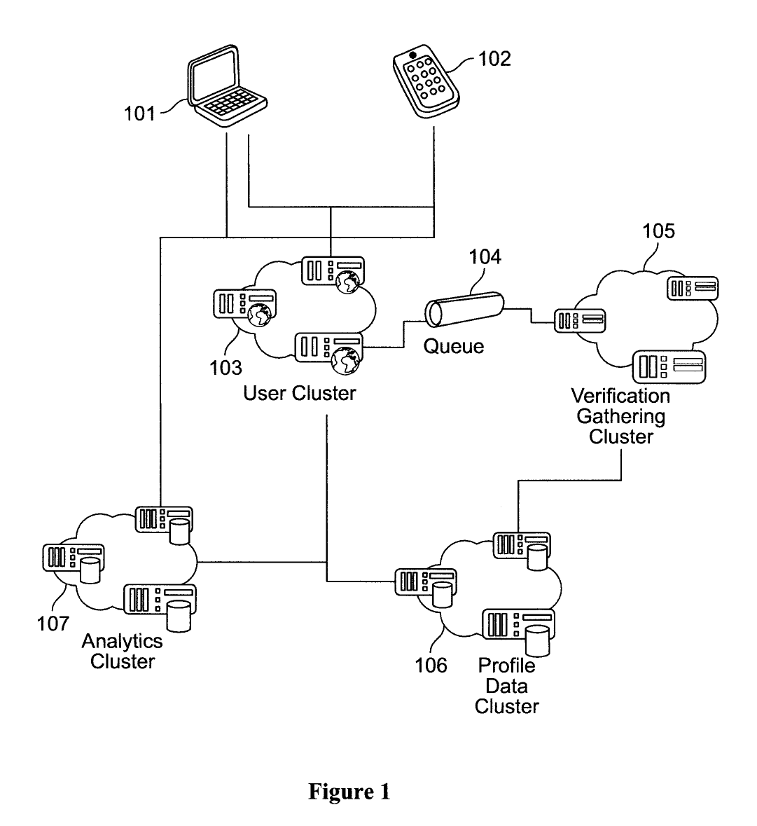

As shown in FIG. 1, a system is used to verify that a user is operating a user computer, acquire personalized information on the user, generate at least one PIN, and use the PIN to provide the personalized information (or a portion thereof) to a non-user computer. As shown in FIG. 1, the system may comprises a plurality of clusters (e.g., user cluster 103, verification gathering cluster 104, profile data cluster, and analytics cluster 107) that are configured to communicate with at least one computer (101, 102) (e.g., a user computer, a non-user computer, etc.).

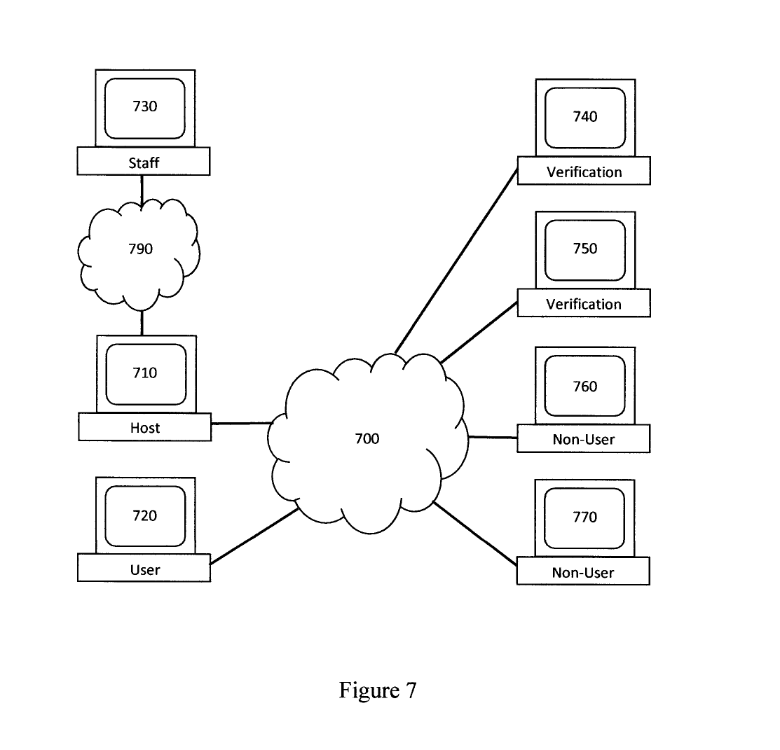

At a higher level, as shown in FIG. 7, a host computer 710 (which may include the above-identified clusters) is configured to communicate with a plurality of computers via a wide area network 700 (e.g., the Internet), including at least one user computer 720, a plurality of non-user computers (e.g., 760, 770), and a plurality of verification computers (e.g., 740, 750), and at least one staff computer 730 over a network (e.g., a LAN, Internet, etc.). It should be appreciated that the present invention is not limited to the number and/or type of computers shown in FIG. 7. For example, the host computer may be made up a plurality of computers (e.g., servers, etc.) in communication with one another, may be configured to communicate with more or less than two non-user computers, and may be configured to communication with any user computer generally known by those skilled in the art (e.g., desktop, laptop, tablet, smartphone, set-top box, television, etc.). It should also be appreciated that the present invention is not limited to any particular type of verification computer, and includes any device or service that is configured to acquire or provide personalized information on the user, such as a credit reporting service, a criminal background reporting service, etc. It should further be appreciated that the staff computer may be configured to acquire and/or provide personalized information on the user automatically (e.g., an application may be used to acquire and/or provide information via the Internet, a staff member may input information, a staff member may provide information to the host computer, etc.).

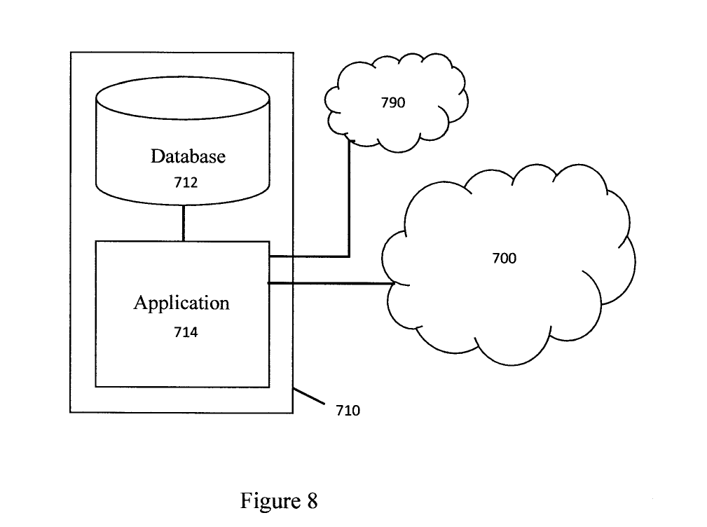

As shown in FIG. 8, the host computer 710 may further comprise at least one database 712 and at least one application 714. It should be appreciated that the present invention is not limited to the number and/type of databases shown in FIG. 8. For example, the present invention may include one or more storage devices (e.g., memory, database, etc.), locally and/or remotely located, and for storing data necessary for operation of the present invention (e.g., machine-readable instructions, user account information, non-user information, personalized information on the user, at least one PIN, etc.). The present invention is also not limited to the number and/or type of applications shown in FIG. 8. For example, the present invention may include one or more applications, locally and/or remotely located.

In one embodiment of the present invention, the application 714 is configured to communicate with at least four types of devices (e.g., user, non-user, verification, and staff). In particular, the application 714 is configured to communicate with the user computer (see FIG. 7 at 720), allowing a user to (i) create a user account, (ii) verify the user's identity, (iii) request background information on the user, (iv) request at least one PIN, and (v) link a PIN with a verification type. The application 714 is further configured to communicate with the verification computers (see FIG. 7 at 740, 750) and/or the staff computer (see FIG. 7 at 730) to acquire personalized data on the user. The application 714 is also configured to communicate with at least one non-user computer (see FIG. 7 at 760, 770). In particular the application 714 is configured to provide personalized information on the user in response to entry of a PIN, wherein the type of (or portion of the) personalized information provided to the user is based on the verification type linked to the provided PIN. For example, if the user requests a PIN and links to the PIN to social verification (e.g., age, marital status, criminal record, etc.), then the application will provide such information to a non-user computer in response to entering the PIN. In other words, by linking the PIN to social verification, the user is instructing the application to provide social verification data (e.g., age, marital status, criminal record, etc.) in response to entry of the PIN (e.g., by a non-user computer). This allows the user to control the type (or amount) of information provided in response to entry of the PIN (e.g., by a non-user, such as a third party). Such a system not only puts the burden on the user, but also ensures that the personalized information is complete, since the user is requesting the information and can review it for accuracy before it is provided to a non-user.

Before addressing details of the system, which may be performed by the application (see FIG. 8 at 714), a brief description of FIG. 1 will be provided. The system of the present invention may be made up of several machines that work in conjunction with each other to complete the system. The system of the present invention may also be configured to communicate with other computing devices, such as user devices 101, 102. The user devices 101, 102 may be configured to run software that handles the display of data from the personal verification system and will capture information regarding operators of the devices (e.g., users, or at least one non-user if at least one device is a non-user computer), etc.). All data displayed (or gathered) by the device 101, 102 is provided by (or to) the user cluster portion of the system 103. The user cluster 103 is responsible for enforcing security and accessing data from the profile data cluster 106 on behalf of the user devices 101, 102. The user cluster 103 may communicate with the verification-gathering cluster 105 over a data queue 104. The user cluster 103 uses the data queue 104 to generate background job requests. The verification-gathering cluster 105 takes jobs from the queue and uses various data sources available on-line via private connections. Data gathered by the verification cluster 105 is then stored and processed by the profile data cluster 106.

All machines (user devices 101, 102, user cluster 103, verification cluster 105, data queue 104, and profile data cluster 106) report back to the analytics cluster 108 regarding the current state of their work, current requests and the status of the request. The analytics cluster 107 is used to run the verification systems security checks and acts as a central system for auditing all requests and data changes. It should be appreciated that the present invention is not limited to the types and/or number of clusters shown in FIG. 1. For example, a single cluster may be used to perform both verification gathering and profile data functions, as described above. It should also be appreciated that the clusters shown in FIG. 1 could be constructed using hardware, software, or any combination of the two. For example, the user cluster portion of the system may be constructed using customized hardware or a general purpose computer (or server) operating customized software (e.g., a custom GUI application).

Referring back to FIG. 8, the application 714 may allow an individual to become a user (or member) of the verification system by allowing the user to generate (or create) an account. This may be done by allowing the user to enter certain information on the user (e.g., name, address, age, social security number, etc.), and select a user name and password. The user name and password will allow the user to subsequently log onto their account and interact with the system (e.g., request a background check, check status of an order, check non-user access to their personal information, request a PIN, link a PIN to a type of verification, change their settings, change their personal information, change their password, etc.).

After a user has an account, the user may request that the system run at least one background check on the user. While the present application will refer to a single background check, it should be appreciated that the personal verification system may be configured to perform different background checks, depending on the needs of the user. For example, the system may be configured to acquire information on the user that may be relevant to a potential employer, a potential landlord, a potential suitor, etc. In doing so, the system may request information from at least one credit reporting agency, at least one criminal reporting system (e.g., city criminal database, county criminal database, state criminal database, federal criminal database, etc.), and various other public/private agencies/systems (e.g., secretary of state, city hall, county clerk, county controller, Google, Facebook, Lexis-Nexis, medical records, etc.).

If a request for a background check is received from a user computer, the system will first need to verify that the user is indeed operating the user computer. This is generally done by gathering data that only the user may know, such as where they were born, where they went to school, where they previously lived, etc. Questions are then presented to the operator of the user computer. If the answers provided (as typed in, or clicked if the questions are multiple choice) are accurate (or are accurate enough (e.g., 2 out of 3, etc.)), then it is assumed that the operator of the user computer is indeed the user, and a background check on the user is performed.

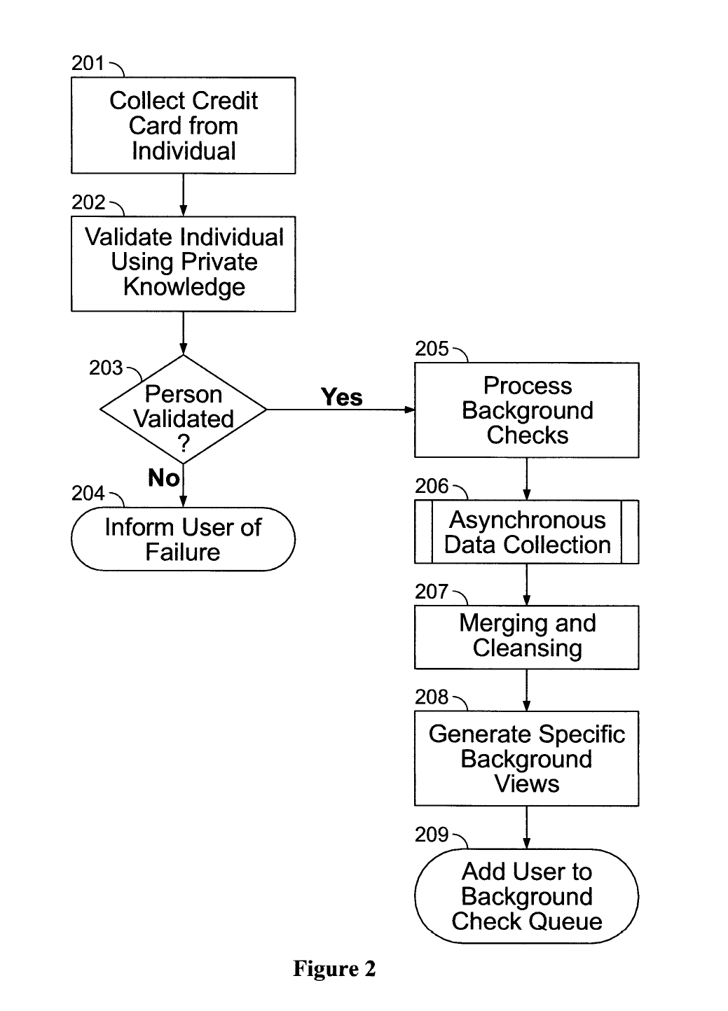

The foregoing is illustrated in greater detail in FIG. 2. When an individual wishes to engage with the personal verification system they will first register with the system, and then provide basic information such as a valid credit card number at step 201. The system will then access basic account and other information regarding the individual at step 202. The individual will then be asked to respond to a set of questions that only the user will be able to answer at step 203. This is done in order to validate the credit card and determine that they are indeed the user (i.e., the owner of the credit card). If the individual is able to answer the questions they will then continue to the next step of the background check process. If the individual is not able to answer the questions, then the system will inform them at step 204 that verification has failed, and that they should contact customer service or re-enter certain information.

The background check process will be handled by multiple systems some of which may be mutual and outside of the personal verification system's control. A master system will control the collection of background check processes and will allow for continuous updates to the individual's profile (see step 205). This system has the ability to manage multiple simultaneous background check processes for multiple individuals across multiple jurisdictions. The primary job of the master system will be to control the asynchronous data collectors (see step 206) and to farm the output from the data collectors to a merging and cleansing process that will continuously update the individual's background check and provide scores to indicate the completeness of the data (see step 207). As data is collected, cleansed and merged a series of specific reports pertaining to different background check types will be generated to ensure that data is not shared across background check domains (see step 208). Since the background check process is only complete on the termination of the service or the death of the individual, the process will be continuous and the individual's background check will be rerun in a queue (see step 209) feeding back to the master system (see step 205).

It should be appreciated that the types of information acquired on a user may vary based on the user's needs, or the type of background check requested by the user. While the types of background checks may vary, information generally collected may include the user's name, current/past address, age (birth date), gender, marital status, relatives (parents, siblings, children, etc.), criminal records, real estate records, vehicle records, current photo, social security number, driver's license number, education, professional licenses, legal issues (civil suits, judgments, bankruptcy, foreclosures, etc.), credit score, revolving credit, current/past employment, medical records (STDs, HPV status, etc.), and all other data generally available via criminal, civil, medical, and credit reporting agencies/systems (public and private).

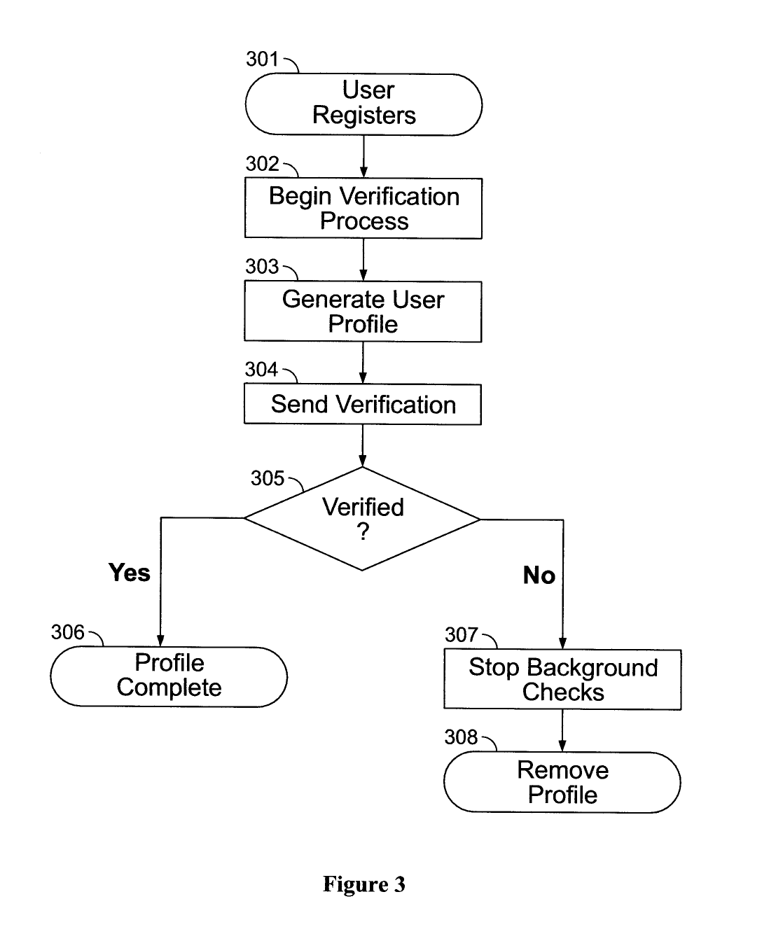

As previously mentioned, a user will typically be required to register with the system before a background check is conducted. However, they system may also allow a user to register after a background check has been requested. For example, as shown in FIG. 3, when an individual which to engage with the personal verification system at step 301, they will engage with the verification process at step 302 (see FIG. 2), which will begin with the background check process. While the process runs, the individual will continue with the registration process and generate a user profile at step 303. Once the profile is complete and information such as their email address have been provided a verification message will be sent via email, text, or other mechanism using information from the user profile at step 304. The verification will have a set timeout. If the individual does not response within the timeout (see step 305) the individual's background check will be cancelled at step 307 and their profile will be removed or archived from the system at step 308. If the individual acknowledges the verification message, their profile will be marked complete at step 306 and background check data will be associated with the individual who is now considered a user of the personal verification system.

In one embodiment of the present invention, the system (e.g., application) (see FIG. 8 at 714) is configured to validate a photo received by the user. In this embodiment, the system can either take a photo of the user (e.g., using a camera portion of the user computer), or allow the user to upload a photo. The system will then use features of the photo (or file) to validate the photo. In one embodiment, the system uses metadata to ensure that the photo was taken at a particular time, at a particular location, from a particular device, from a particular IP address, etc. In another embodiment of the present invention, the system will provide the user with a PIN (or other secure alpha, numeric, or alphanumeric value) and request that the user take a picture holding a printout of the PIN. The system will then use the PIN (as included in the photo), either alone or in conjunction with other data (e.g., metadata) to validate a photo of the user. Once the photo has been validated, the system may use facial recognition software (as known in the art) to match the individual in the photo (e.g., with the PIN) to other photos. This allows the user to submit a system photo, and then submit other photos that are appropriate for sharing with non-users.

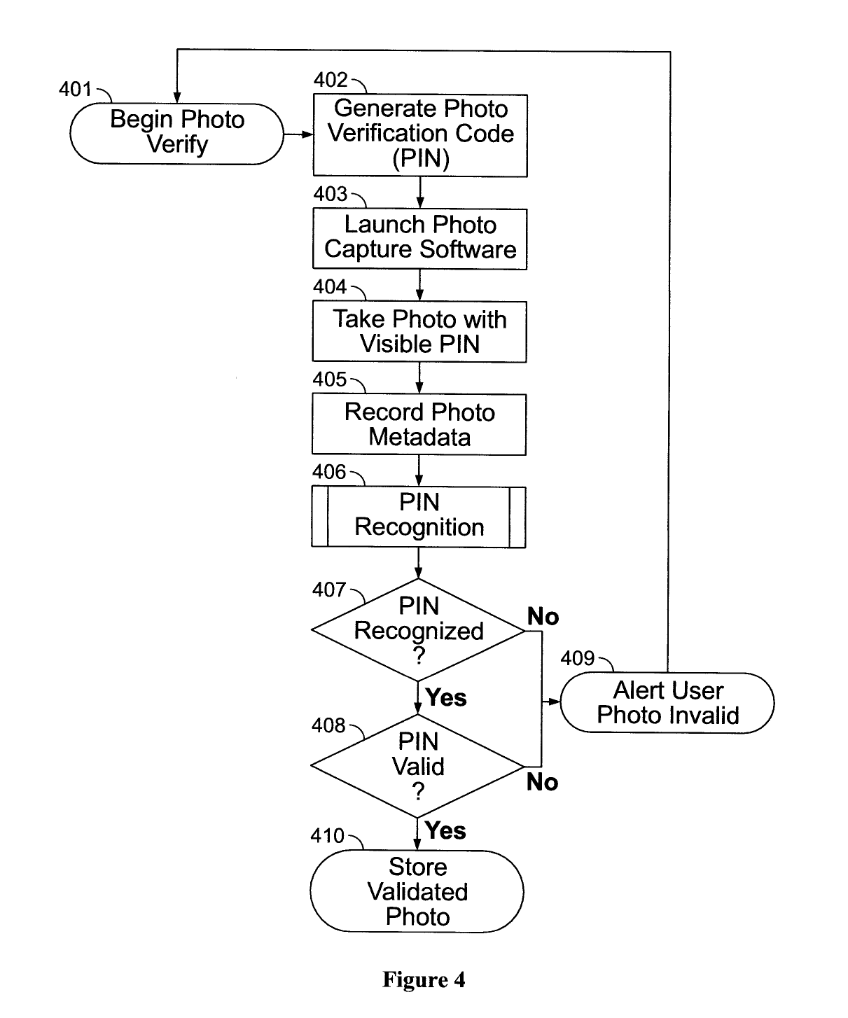

The photo validating aspect of the present invention is shown in greater detail in FIG. 4. As discussed above, the personal verification system may allow a user to create and certify (or validate) photos so that those viewing the photos can be certain that the photos are actually of the user. When a user wishes to create a verified photo they will first request to start the photo workflow at step 401. The system will generate a unique PIN number that will expire within a set period of time at step 402 and which is tied to the particular user at a particular location. If a photo is taken that does not conform to the location or other information encoded and stored with the PIN the PIN will be considered invalid at step 408. The personal verification system will launch an application that will allow for the photo of the user to be captured at step 403 and the user will take a picture with the PIN visible at step 404. The system will capture information regarding when the photo was taken, where the photo was taken, the user account associated with the photo being taken, and the device's network information to aid in validating the validity of the photo at step 405.

The system will then attempt to read the PIN from the photo at step 406. If the PIN can be recognized from the photo then the system will continue to validate the photo at step 407. If the PIN cannot be read, then the user will be alerted and given the opportunity to retake the picture at step 409, at which point the user can restart the process at step 401. If the PIN is recognized, then the PIN is validated at step 408. Validation utilizes the metadata captured from step 405 and the fact the photo had a recognizable PIN to calculate the probability that the photo is genuine. The validation stage looks at the past history of the user, the characteristics of the photo (such as the number of faces found in the photo), the device compared to the user's previous locations captured during registration and usage of the personal verification system, the network information for the device and the history of that device's network information to predict the chance that the photo is not fraudulent. If a determination is made that the past history and the current activity are indicative of fraud, then the system will reject the photo and alert the user that the photo was deemed potentially fraudulent at step 409. If the photo and PIN are verified at step 408, then the system will allow the photo to be stored and used as a validated photo at step 410.

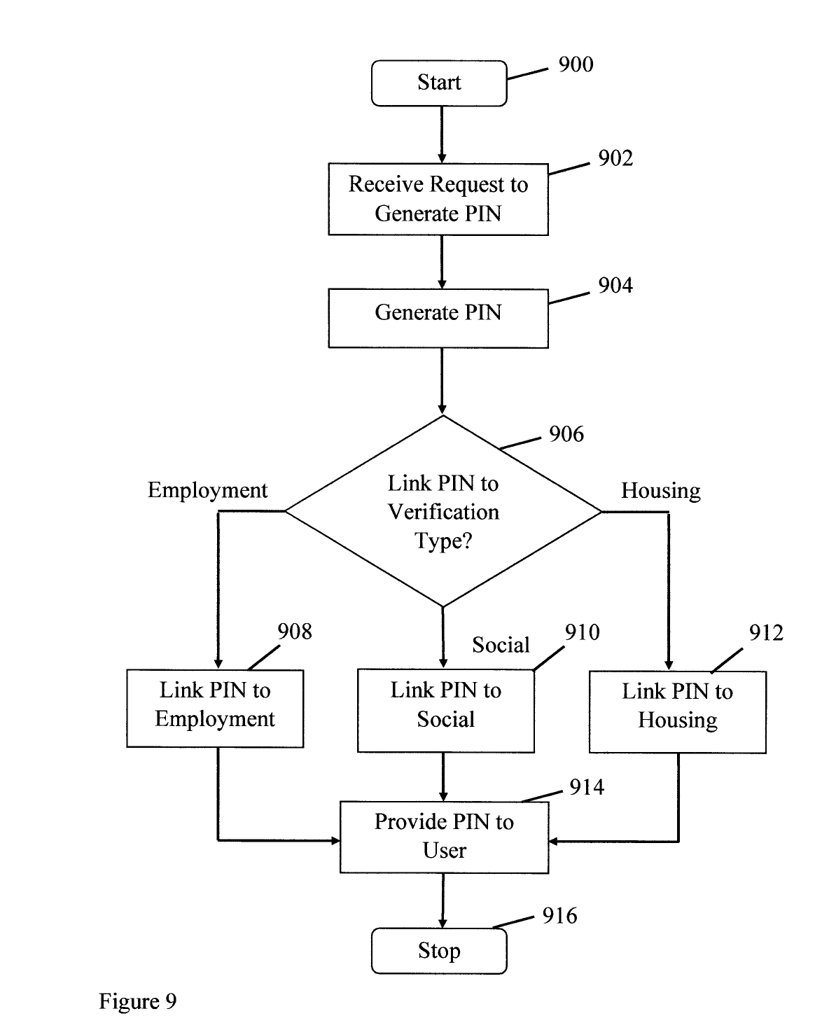

Once the system has information on the user (e.g., at least one photo, background information, etc.), the information (or a portion thereof) can be shared with a third party, referred to herein as a “non-user” (in order to distinguish him or her from the user). To begin the process of sharing information, the system performs the process shown in FIG. 9, starting at step 900. They system first receives a request to generate a PIN from the user at step 902. In response, the system generates a unique PIN at step 904. It should be appreciated that the PIN only has to be unique to the system, and can be created using alpha, numeric, or alphanumeric values, and may be case sensitive. The system may then ask the user to link (or associate) the PIN to a particular verification type (e.g., employment, housing, social, etc.). As discussed below, this will determine the type (or amount) of information provided to the non-user when entering the PIN. For example, if the user selects “employment,” the PIN will be linked to an employment verification type at step 908. Similarly, if the user selects “social” or “housing,” the PIN will be linked to a social or housing verification type, respectively, at steps 910 and 912. The PIN will then be provided to the user at step 914, ending the process at step 916. It should be appreciated that the present invention is not limited to the process shown in FIG. 9, and a process having fewer, additional, or different steps is within the spirit and scope of the present invention. For example, if the user already has a PIN (e.g., the PIN used to validate a photo), the process may begin at step 906, allowing the user to link the PIN to a particular verification type.

Once the user has a PIN, the user can then provide the PIN to at least one non-user. The non-user will then use the PIN to acquire user information from the system. It should be appreciated that while the present invention contemplates that a particular PIN can only be used by a particular individual, or a particular company, such a feature is not a limitation of the present invention. For example, allowing a PIN to be used by multiple people and/or multiple companies is within the spirit and scope of the present invention. It should also be appreciated that while the present invention contemplates that each PIN will expire after a period of time, PINs can be configured to expire or be deactivated based on other criteria (e.g., after a period of non-use, at the request of the user, etc.).

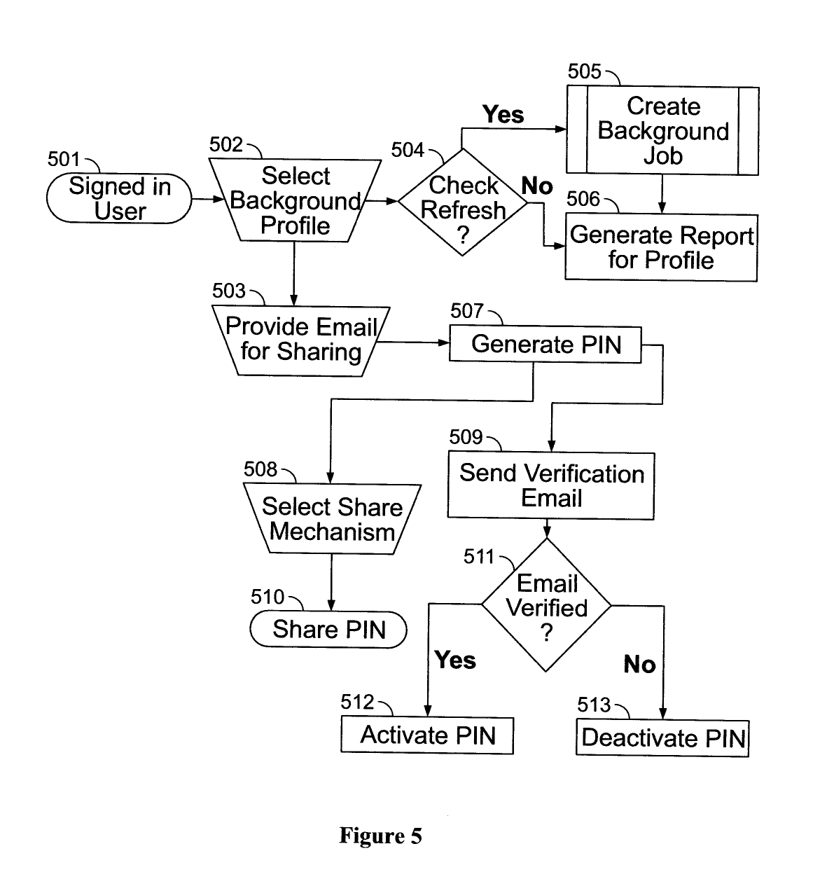

In another embodiment of the present invention, a PIN can be shared using electronic mail. As shown in FIG. 5, and as discussed above, the personal verification system may allow a user to share specific information with other individuals. When a user at step 501 is signed in, they can select a specific type of personal verification system profile at step 502 that contains the information they wish to share with another individual. When a user selects a profile to share at step 502 the personal verification system will check to see if the user's profile needs to be refreshed at step 504 (e.g., if more than a predetermined amount of time has lapsed since the user's profile was last refreshed, etc.). If the profile needs to be refreshed, a background check job will be submitted to the background check subsystem at step 505. If the profile does not need to be refreshed the user's profile report will be generated by the system and stored for an email address for the individual they would like to share their profile with at step 503. Upon providing an email address, the personal verification system will generate a PIN unique to the user and the individual they would like to share information with at step 507. The user will then be asked by the system how their profile will be shared at step 508 and based on the sharing mechanism, such as text message, email, or display, the system will share the PIN with the individual that would like to see the user's profile at step 510.

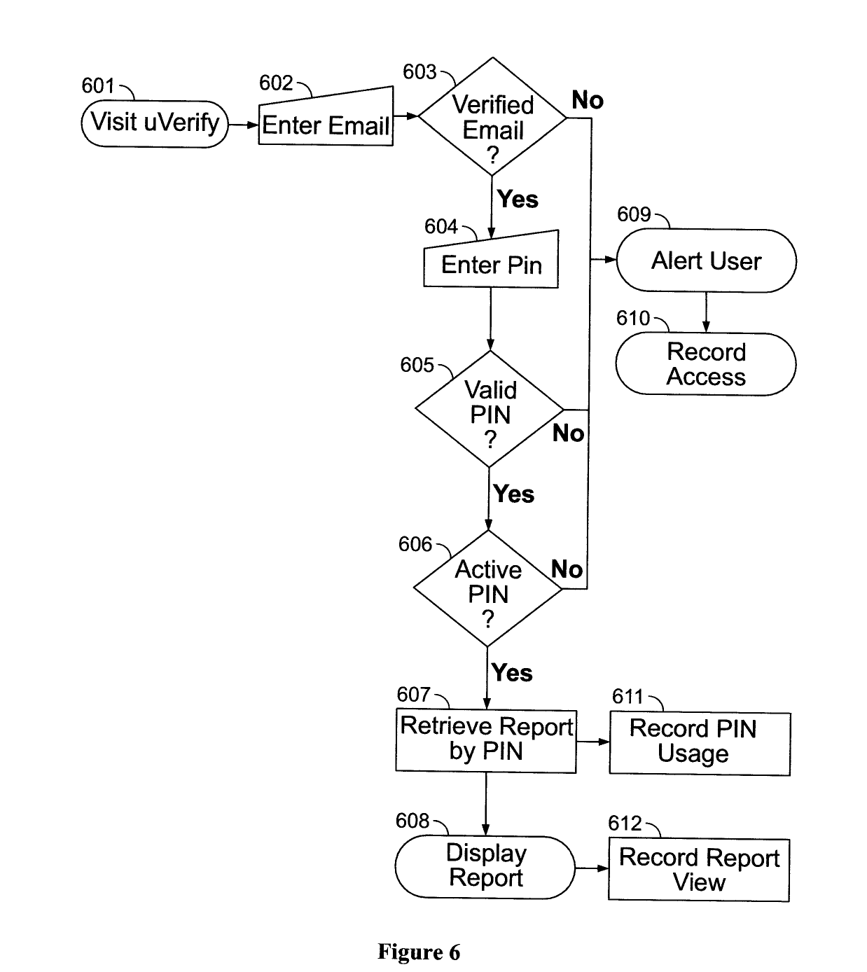

At this point, however, the PIN may still not be active. In order for the system to activate the PIN, the individual that the profile will be shared with must validate the email address provided in step 503. To validate the email, the system will send a unique time sensitive verification email at step 509 to the address provided in step 503. If the email is verified by the individual and the system, the PIN will be activated at step 512. Otherwise the PIN will be deactivated at step 513 and attempts to view the user's profile will be denied and recorded (see FIG. 6).

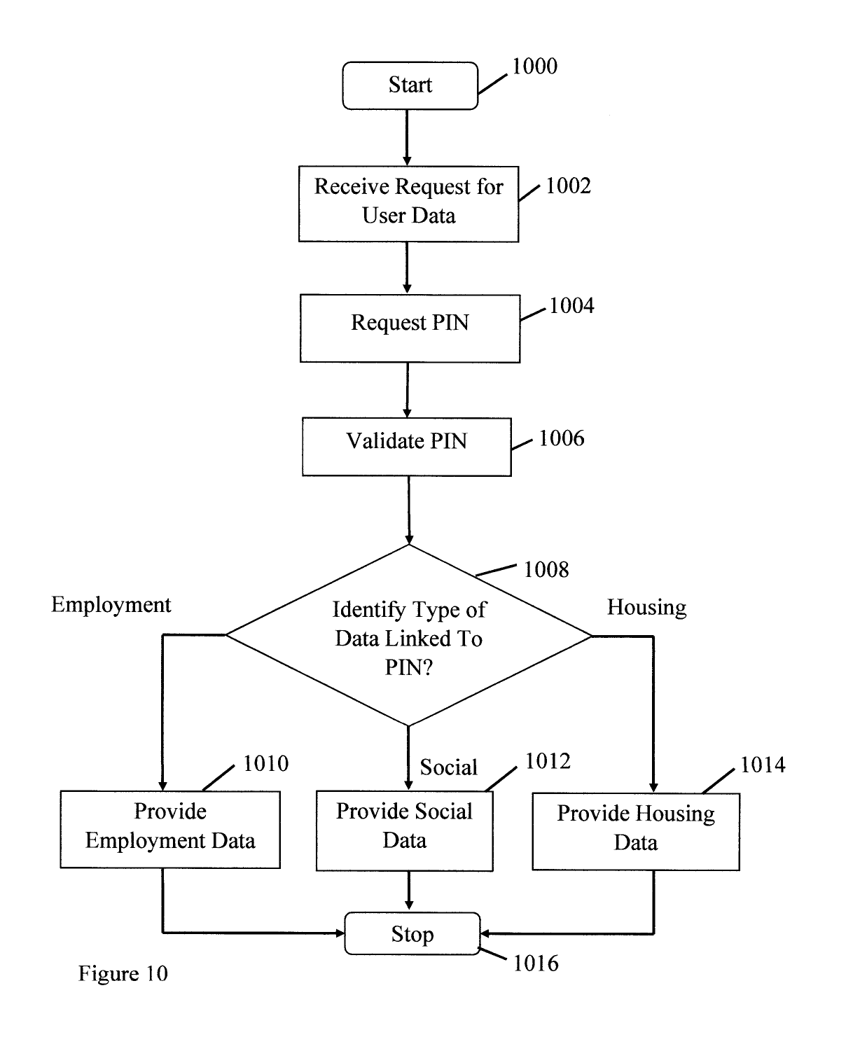

Once a non-user has the PIN, the PIN can be provided to the system to receive information that is linked to the PIN (e.g., a particular subset of information on the user). Such a process is shown in FIG. 10, starting at step 1000. At step 1002 the system receives a request for personalized information. The system then requests and receives a PIN, which is provided by the non-user at step 1004. If the PIN is validated at step 1006, then a determination is made as to what information the PIN is linked to at step 1008. For example, if the PIN is linked to the user and “employment,” then personalized information on the user that is related to employment (e.g., education, past work experience, criminal history, etc.) is provided to the non-user at step 1010, ending the process at step 1016. If the PIN is linked to the user and “social,” then personalized information on the user that is related to social (e.g., age, marital status, photo, criminal background, medical data, etc.) is provided to the non-user at step 1012, ending the process at step 1016. If the PIN is linked to the user and “housing,” then personalized information on the user that is related to housing (e.g., credit rating, employment, etc.) is provided to the non-user at step 1014, ending the process at step 1016. It should be appreciated that the present invention is not limited to the process shown in FIG. 10, and may include fewer, additional, or different steps. For example, in addition to the PIN, the non-user may be required to enter some type of identifying information (e.g., non-user name, non-user company, non-user email address, user name, etc.), or may be required to register and setup an account with a user name and password. Such data can be used to link each PIN to a particular user and a particular non-user, and could allow the non-user to access user information at different times.

If the PIN is distributed using an electronic mail address of the non-user, the personalized information can be accessed as shown in FIG. 6. When an individual wishes to see information on a user of the personal verification system they will first come to the system at step 601 and enter the email address used in the PIN generation from step 503 in FIG. 5. If the email has been verified by the system at step 603 the individual will be able to enter the PIN at step 604, provided in step 510 of FIG. 5. If the PIN is valid at step 605 and the PIN is still active at step 606, then the personal verification system will retrieve the profile report the individual is authorized to see at step 607 and the system will record the usage of the PIN at step 611. Once the report is retrieved it will be displayed to the individual at step 608 and the display of the report will be recorded at step 612. As long as the PIN remains active, because the time frame for the PIN has not passed or the user who the PIN was generated for has not deactivated it, the individual will be able to continue to access the report. If the PIN is expired or invalid, the personal verification system will let the individual know at step 610 and will record the attempt to use an invalid or expired PIN at step 611.

Having thus described several embodiments of a system and method for using a PIN to provide personalized information on a user to at least one non-user, it should be apparent to those skilled in the art that certain advantages of the system and method have been achieved. It should also be appreciated that various modifications, adaptations, and alternative embodiments thereof may be made within the scope and spirit of the present invention. The invention is solely defined by the following claims.

What is claimed is:

1. A method for allowing shared access to personalized information on a user, comprising:
acquiring said personalized information on said user, comprising:
receiving by a host computer a request from said user to gather personalized information on said user;
sending by said host computer verification data to a user computer, said verification data being used to verify that said user is operating said user computer;
receiving by said host computer a response to said verification data from said user computer;
determining whether said response to said verification data verifies that said user is operating said user computer;
acquiring said personalized information on said user if it is determined that said user is operating said user computer;
storing said personalized information in a database; and
providing a first and second personal identification number (PIN) to said user, each one of said first and second PINs comprising a unique alphanumeric value;
sharing said personalized information on said user, comprising:
receiving by said host computer said first PIN and a request for said personalized information from a third party computer;
receiving by said host computer said second PIN and a request for said personalized information from a fourth party computer;
providing in response to said first PIN a first portion of said personalized information to said third party computer; and
providing in response to said second PIN a second portion of said personalized information to said fourth party computer;
wherein said first portion of said personalized information is different, at least in part, from said second portion of said personalized information.

2. The method of claim 1, wherein said step of sending by said host computer verification data to a user computer further comprises sending a plurality of multiple choice questions to said user computer, said multiple choice questions being based on data that would be known by said user.

3. The method of claim 2, wherein said steps of receiving by said host computer a response to said verification data and determining whether said response to said verification data verifies that said user is operating said user computer further comprise receiving answers to said multiple choice questions from said user computer and determining whether said answers are correct.

4. The method of claim 1, wherein said step of acquiring said personalized information on said user further comprises gathering credit report data on said user and gathering criminal history data on said user, said criminal history data being acquired from a plurality of criminal records repositories.

5. The method of claim 1, wherein said plurality of criminal records repositories comprises at least two of a national sex offender registry, a local sex offender registry, a federal criminal records repository, a state criminal records repository, and a county criminal records repository.

6. The method of claim 4, wherein said step of acquiring said personalized information on said user further comprises gathering civil litigation data on said user.

7. The method of claim 1, wherein said step of acquiring said personalized information on said user further comprises:
receiving a plurality of photos from said user, wherein a first one of said plurality of photos depicts an individual holding a printout of a PIN;
determining whether (i) said PIN corresponds to said first PIN, and (ii) the individual depicted in the first one of the plurality of photos corresponds to an individual depicted in a second one of said plurality of photos; and
storing at least said second one of said plurality of photos in said database as a portion of said personalized information on said user.

8. The method of claim 1, further comprising the steps of (i) receiving from said user a request for said first PIN, and (ii) receiving from said user a request for said second PIN, wherein said request for said first PIN identifies said first portion of said personalized data on said user, and said request for said second PIN identifies said second portion of said personalized data on said user.

9. The method of claim 1, further comprising the step of receiving a request for said second PIN, wherein said request for said second PIN identifies said second portion of said personalization data on said user.

10. The method of claim 1, further comprising the steps of linking said first PIN to a first one of a plurality of verification types, and linking said second PIN to a second one of a plurality of verification types, wherein said first one of said plurality of verification types corresponds to said first portion of said personalized information and said second one of said plurality of verification types corresponds to said second portion of said personalized information.

11. The method of claim 10, wherein said plurality of verification types comprises verification for employment, verification for housing, and verification for social encounters.

12. The method of claim 10, further comprising the steps of (i) receiving a request from said user for said first PIN, (ii) receiving a request from said user for said second PIN, (iii) receiving a request from said user to associate said first PIN with said first one of said plurality of verification types, and (iv) receiving a request from said user to associated said second PIN with said second one of said plurality of verification types.

13. A system for providing shared access to personalized information on a user, wherein a user computer (i) submits a request that said personalized information on said user be gathered and (ii) verifies that said user computer is being operated by said user, comprising:
A computer system operatively connected to a network and including a memory device, wherein said memory device is adapted to store said personalized information on said user, store a plurality of personal identification numbers (PINs), wherein each one of said PINs comprises an alphanumeric value, and store machine-readable instructions adapted to:
acquire said personalized information on said user;
provide a first one and a second one of said plurality of PINs to said user;
receive said first one of said plurality of PINs and a request for said personalized information from a third party computer;
receive said second one of said plurality of PINs and a request for said personalized information from a fourth party computer;
providing in response to said first one of said plurality of PINs a first portion of said personalized information to said third party computer; and
providing in response to said second one of said plurality of PINs a second portion of said personalized information to said fourth party computer;
wherein said first portion of said personalized information is different, at least in part, from said second portion of said personalized information.

14. The system of claim 13, wherein said machine-readable instructions are further adapted to acquire credit report data on said user and criminal history data on said user, said criminal history data being acquired from a plurality of criminal records repositories.

15. The system of claim 14, wherein said plurality of criminal records repositories comprises at least two of a national sex offender registry, a local sex offender registry, a federal criminal records repository, a state criminal records repository, and a county criminal records repository.

16. The system of claim 13, wherein said machine-readable instructions are further adapted to acquire civil litigation data on said user.

17. The system of claim 13, wherein said machine-readable instructions are further adapted to:
receive a plurality of photos from said user, wherein a first one of said plurality of photos depicts an individual holding a printout of a PIN;
determine whether (i) said PIN corresponds to said first one of said plurality of PINs, and (ii) the individual depicted in the first one of the plurality of photos corresponds to an individual depicted in a second one of said plurality of photos; and
store at least said second one of said plurality of photos in said database as a portion of said personalized information on said user.

18. The system of claim 13, wherein said machine-readable instructions are further adapted to (i) receive a request from said user for said first one of said plurality of PINs, (ii) receive a request from said user for said second one of said plurality of PINs, (iii) receive a request from said user to associate said first one of said plurality of PINs with a first one of a plurality of verification types, said first one of said plurality of verification types corresponding to said first portion of said personalized information, and (iv) receive a request from said user to associated said second one of said plurality of PINs with a second one of said plurality of verification types, said second one of said plurality of verification types corresponding to said second portion of said personalized information.

19. The system of claim 18, wherein said plurality of verification types comprises verification for employment, verification for housing, and verification for social encounters.

20. A method for allowing shared access to a user's personalized information, comprising:
receiving by a host computer a request from a user computer to gather said personalized information on said user;
verifying that said user is operating said user computer;
acquiring said personalized information if it is verified that said user is operating said user computer;
receiving requests from said user for a plurality of personal identification numbers (PINs), each one of said plurality of PINs comprising a unique alphanumeric value;
receiving requests from said user to associate each one of said plurality of PINs with one of a plurality of verification types, said plurality of verification types comprising at least verification for employment, verification for housing, and verification for social encounters.
providing by said host computer said plurality of PINs to said user;
receiving by said host computer said plurality of PINs, respectively, from a plurality of non-user computers; and
providing in response to each one of said plurality of PINs a portion of said personalized information to a corresponding one of said plurality of said non-user computers, said portion corresponding to a verification type associated with a PIN provided by said non-user computer.
